(19) United States
(12) Patent Application Publication
(10) Pub. No.: US 2020/0086514 A1
(43) Pub. Date: Mar. 19, 2020

(54) PNEUMATIC SCISSOR TOOL

(71) Applicant: DIN LONG INDUSTRIAL CO., LTD., Taoyuan (TW)

(72) Inventor: Jung-Fu HSIEH, Taoyuan (TW)

(21) Appl. No.: 16/572,312

(22) Filed: Sep. 16, 2019

(30) Foreign Application Priority Data
Sep. 17, 2018 (TW) 107212624

(51) Int. Cl. B26B 15/00

(52) U.S. Cl. CPC B26B 15/00; B23D 29/005

(57) ABSTRACT

A pneumatic scissor tool comprises a tool housing, a movable blade and a power assembly, the tool housing comprises an assembly space, a mounting opening and a fixed blade, wherein the fixed blade is arranged at the mounting opening, the movable blade is arranged at the mounting opening corresponding to the fixed blade. Further, the power assembly comprises a pneumatic motor, a transmission shaft and an eccentric driving wheel. The eccentric driving wheel is connected with the transmission shaft and comprises an outer ring member, a bearing block, a column mounting space and a plurality of supporting columns, the outer ring member is used for pushing the movable blade, the bearing block is arranged in the outer ring member and installed in an eccentric manner with the transmission shaft, and the supporting columns is arranged in the column mounting space and are tightly connected with each other.

### FIELD OF THE INVENTION

The invention relates to a power scissor tool, in particular to a pneumatic scissor tool which comprises an eccentric driving wheel and is used for bearing larger reaction force.

### BACKGROUND OF THE INVENTION

As the industrial technology advances, conventional scissors, which apply force by holding the handle of the scissor by hands, and the blade of which is pushed according to the lever principle to cut hard materials, are not favored by consumers anymore, but the power scissors driven by pneumatic or electric power and the like are used instead. Further, nowadays, the shearing target is no longer just an article with no obvious rigidity such as paper or branches, but the implementation of shearing metal plates is appeared.

A related conventional power scissor is seen in TW M297827, which provides a power scissor structure including essentially a hollow grip, a front cover holder connected to the hollow grip, and a shear blade connected to the front cover holder, wherein an electric motor and a driving assembly driven by the electric motor are arranged in the hollow grip, and the driving assembly comprises a cam. When the cam rotates in an eccentric manner, the shearing blade performs shearing action to shear the metal plate. However, the cam is not only actuated to act on the shear blade but bears the shear stress from the shear blade. Thus, the cam may be damaged due to insufficient structural strength as the hardness of the material to be sheared is too high.

### SUMMARY OF THE INVENTION

The main purpose of the invention is to solve the problem that the shearing thickness of a power scissor tool is limited because a cam structure used by a conventional power scissor cannot bear larger reaction force.

To achieve the above object, the present invention provides a pneumatic scissor tool comprising a tool housing, a movable blade and a power assembly. The tool housing comprises an assembly space, a mounting opening and a fixed blade, wherein the assembly space is formed in the tool housing, the mounting opening is communicated with the assembly space, and the fixed blade is arranged at the mounting opening. The movable blade is arranged at the mounting opening corresponding to the fixed blade, and the power assembly comprises a pneumatic motor, a transmission shaft and an eccentric driving wheel. Also, the pneumatic motor is arranged in the assembly space, the transmission shaft is connected with the pneumatic motor, the eccentric driving wheel is connected with the transmission shaft and pushes the movable blade to perform a shearing stroke when rotating, and the eccentric driving wheel comprises an outer ring member, a bearing block, a column mounting space and a plurality of supporting columns. The outer ring member is used for pushing the movable blade, the bearing block is arranged in the outer ring member and installed in an eccentric manner with the transmission shaft, the column mounting space is formed between the outer ring member and the bearing block, and the plurality of supporting columns are arranged in the plurality of column mounting space and are tightly connected with each other.

In one embodiment, the outer ring member comprises a ring wall and a retaining wall extending from one side of the ring wall toward the direction of the column mounting space to retain the plurality of supporting columns.

In one embodiment, the ring wall is an arcuate wall.

In one embodiment, a distance is located between the retaining wall and the bearing block, and a diameter of each of the plurality of supporting columns is equal to the distance.

In one embodiment, the power assembly comprises a stop cap disposed corresponding to the bearing block and penetrated by the transmission shaft, the stop cap is disposed in an eccentric manner relative to the bearing block.

In one embodiment, the stop cap includes a first mounting hole formed in the stop cap.

In one embodiment, the bearing block includes a body contacting the plurality of supporting columns and a second mounting hole formed in the body and assembled to the transmission shaft, the second mounting hole is offset from a center of the body.

In one embodiment, the movable blade includes a blade section arranged at the mounting opening corresponding to the fixed blade, and a connecting section extending from the blade section and driven by the eccentric driving wheel.

In one embodiment, the connecting section of the movable blade is formed by two arms spaced at interval disposed at two opposite ends of the eccentric driving wheel.

In one embodiment, the tool housing comprises a first housing half in which provides the pneumatic motor to dispose, and a second housing half assembled with the first housing half and formed with the mounting opening On the basis of the disclosure above, the invention has the following characteristics compared with the conventional power scissor: according to the invention, the plurality of supporting columns are tightly connected with each other, so that the eccentric driving wheel is able to bear larger reaction force. Specifically, the movable blade applies a shearing force to materials during the shearing process of the movable blade, thereby the eccentric driving wheel is able to bear larger reaction force due to the fact that the plurality of supporting columns are tightly connected with each other, and thus the pneumatic scissor tool shears materials with higher hardness or thicker thickness.

### BRIEF DESCRIPTION OF THE DRAWINGS

FIG. 1 is a partially exploded structural schematic view (I) of one embodiment of the present invention.

FIG. 2 is a partially exploded structural schematic view (II) of one embodiment of the present invention.

FIG. 3 is a cross-sectional structural schematic view of one embodiment of the present invention.

FIG. 4 is a schematic side view of the eccentric driving wheel of one embodiment of the present invention.

FIG. 5 is a schematic cross-sectional view of the eccentric driving wheel of one embodiment of the present invention.

FIG. 6 is a schematic diagram illustrating an implementation state of one embodiment of the present invention.

### DETAILED DESCRIPTION OF THE PREFERRED EMBODIMENTS

The detailed description and technical contents of the present invention will now be described with reference to the drawings as follows:

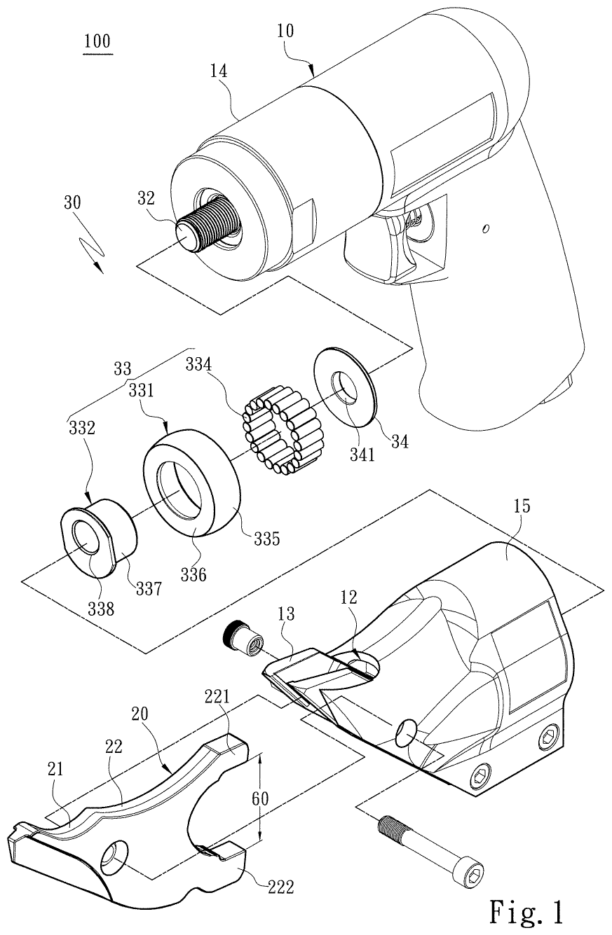

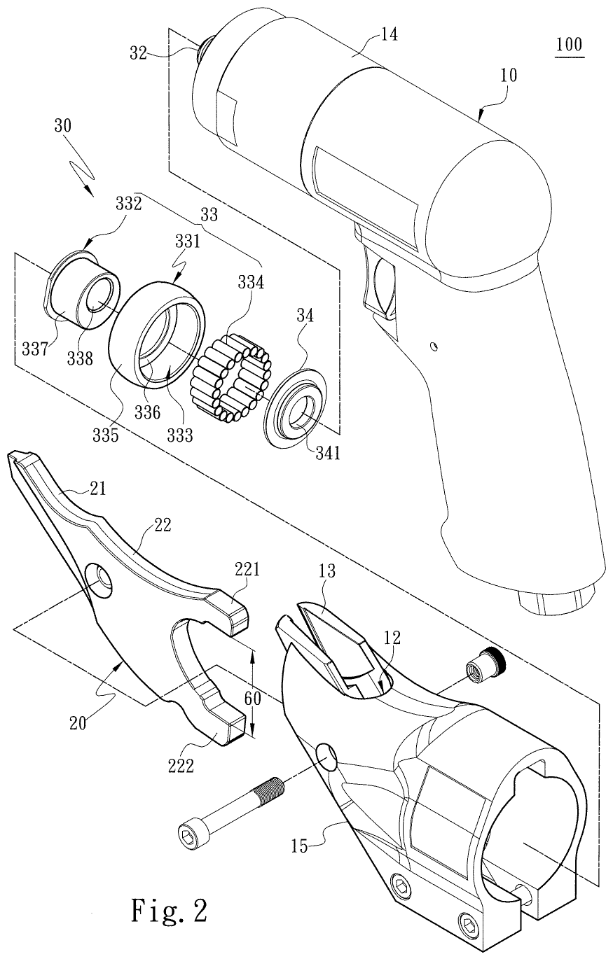

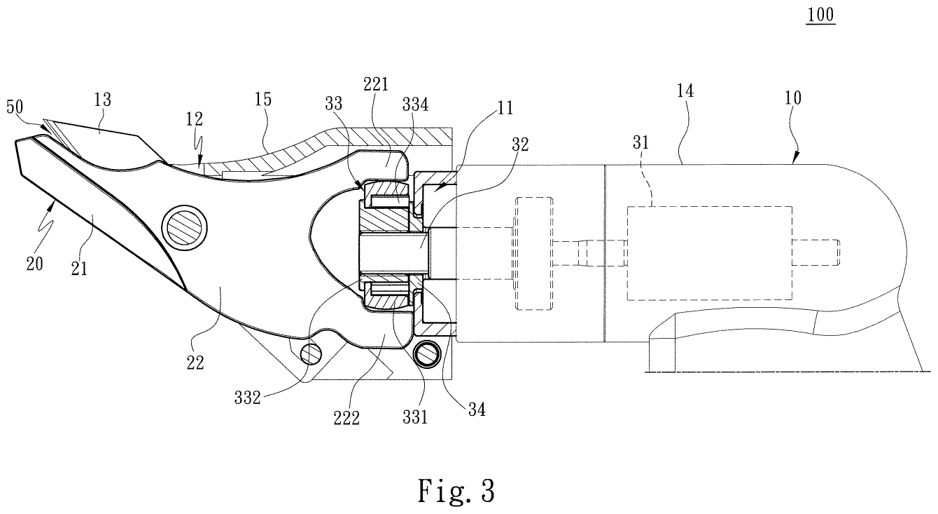

Referring to FIG. 1, FIG. 2, and FIG. 3, the present invention provides a pneumatic scissor tool 100 that is able to shear a material (e.g., an iron plate, etc.). The pneumatic scissor tool 100 includes a tool housing 10, a movable blade 20, and a power assembly 30. The tool housing 10 includes an appearance that is designed according to the user's needs or habits. The tool housing 10 is formed with an assembly space 11 and a mounting opening 12, wherein the mounting opening 12 is located at one end of the whole structure of the tool housing 10 and communicates with the assembly space 11. In addition, the tool housing 10 is provided with a fixed blade 13 at the position of the mounting opening 12. On the other hand, for the purpose that the movable blade 20 is fitted with the fixed blade 13, the movable blade 20 is provided at the mounting opening 12 and corresponding to the fixed blade 13. Further, a part of the movable blade 20 is located in the assembly space 11, and the remaining part of the movable blade 20 is exposed outside the mounting opening 12. In addition, the fixed blade 13 and the movable blade 20 may be a pivoted relation, so that the movable blade 20 is allowed to swing relative to the fixed blade 13 by a pivoted position of the movable blade 20 serves as a fulcrum.

Accordingly, the power assembly 30 includes a pneumatic motor 31, a transmission shaft 32, and an eccentric driving wheel 33. The pneumatic motor 31 is arranged in the assembly space 11. Further, a bearing or a planetary gear set and the like which are matched and implemented in the power assembly 30 are regarded as a part of the pneumatic motor 31. The internal structure of the pneumatic motor 31 is not the main point of the present application, and a person skilled in the art would know the internal structure of the pneumatic motor 31 from relevant information of the pneumatic scissors. Thus, it will not be described in detail herein. Further, the transmission shaft 32 is assembled to the pneumatic motor 31, and the transmission shaft 32 is rotated as being driven by the pneumatic motor 31.

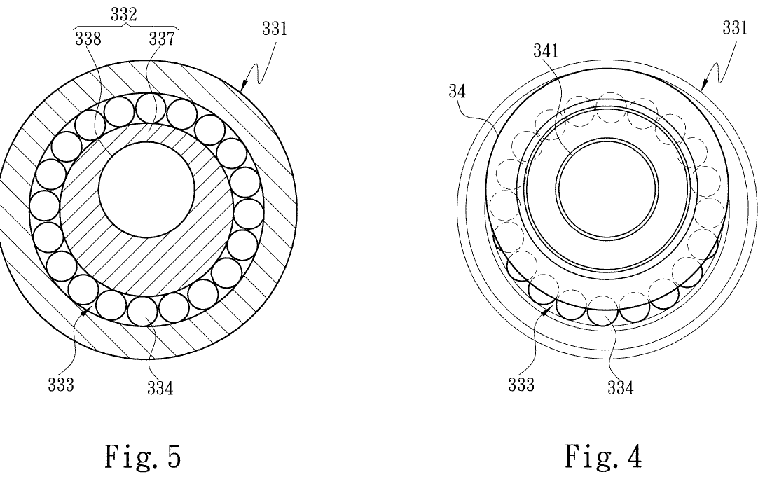

Further, referring to FIG. 1, FIG. 2, FIG. 3, FIG. 4, and FIG. 5, the eccentric driving wheel 33 is connected to the transmission shaft 32. Further, the center of the eccentric driving wheel 33 is offset from the center of the transmission shaft 32. The eccentric driving wheel 33 comprises an outer ring member 331, a bearing block 332, a column mounting space 333 and a plurality of supporting columns 334, wherein the outer ring member 331 is located at the relative outer side of the whole of the eccentric driving wheel 33 and is used for pushing the movable blade 20, and the outer ring member 331 is hollow. The bearing block 332 is provided in the outer ring member 331. The bearing block 332 is mounted with the transmission shaft 32, and the size of the bearing block 332 is significantly smaller than the inner diameter of the outer ring member 331, thereby the column mounting space 333 is formed. Moreover, the size of the plurality of supporting columns 334 is uniform, the plurality of supporting columns 334 are inserted into the column mounting space 333 sequentially, and the plurality of supporting columns 334 are tightly connected. That is, each of the plurality of supporting columns 334 is contacted directly with the adjacent supporting columns 334, and there is no significant gap between any two of the plurality of supporting columns 334. Further, each of the plurality of supporting columns 334 is in the form of a cylinder which is axially inserted into the column mounting space 333 and arranged around the circumference of the bearing block 332.

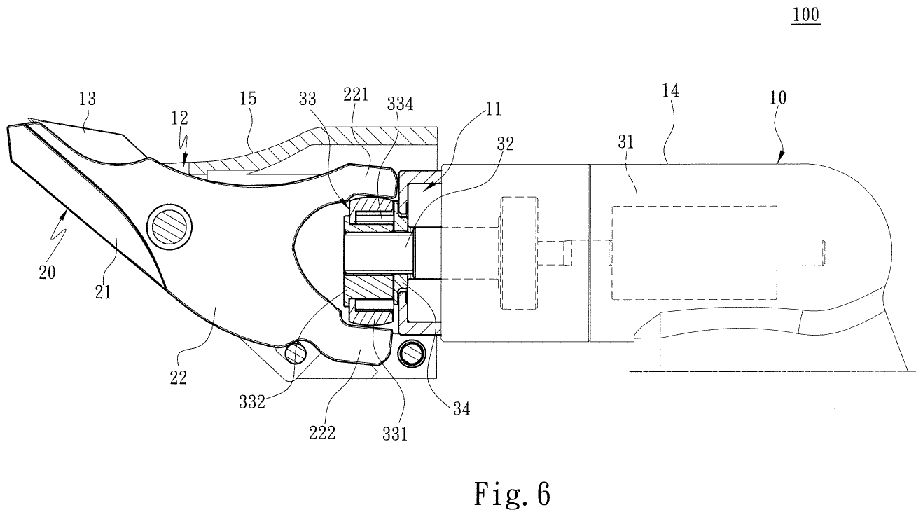

Accordingly, the present invention is exampled with embodiments of the pneumatic scissor tool 100. Referring to FIG. 3 and FIG. 6, assuming that the initial state of the pneumatic scissor tool 100 is shown as FIG. 3 and the implemented state is shown as FIG. 6. More specifically, when the pneumatic scissor tool 100 is not sheared, the eccentric driving wheel 33 deflects the movable blade 20 opposite to the fixed blade 13 to form a shear opening 50. At this time, an object to be cut which is not shown in figures may be placed in the shear opening 50 in preparation for cutting by a user. By an activation switch which is not shown in figures on the pneumatic scissor tool 100, a compressed gas is supplied to the pneumatic motor 31, the pneumatic motor 31 is rotated by the interaction of the compressed gas and drives the transmission shaft 32. At this time, since the eccentric driving wheel 33 is disposed in an eccentric manner with respect to the transmission shaft 32, the eccentric driving wheel 33 follows an elliptical path when moving. Further, the movable blade 20 is pushed to perform a shearing stroke with respect to the fixed blade 13 so that the object to be sheared at the shear opening 50 is shared by the movable blade 20. After a shear is completed, if the eccentric driving wheel 33 is not continuously driven by the transmission shaft 32, the eccentric driving wheel 33 will normally place the movable blade 20 into the initial state as shown in FIG. 3.

Thus, the plurality of supporting columns 334 disposed tightly may disperse the stress experienced by the eccentric driving wheel 33, thereby increasing the reaction force that can be experienced by the eccentric driving wheel 33, allowing the pneumatic scissor tool 100 of the present invention to shear thicker materials. For example, conventional pneumatic scissors can shear a maximum thickness of 1.2 millimeters, while the present invention can shear a maximum thickness of 1.4 millimeters. Thus, the shear capability of the pneumatic scissor tool 100 in the present invention is improved.

Referring to FIG. 1, FIG. 2, FIG. 3, FIG. 4, and FIG. 5, in one embodiment, the outer ring member 331 comprises a ring wall 335 and a retaining wall 336 extending from one side of the ring wall 335 toward the column mounting space 333 to increase the assembling convenience and structural strength of the eccentric driving wheel 33. The retaining wall 336 is used to support the plurality of supporting columns 334. Besides, one side of the outer ring member 331 formed with the retaining wall 336 is placed on the work platform during the assembly of the eccentric driving wheel 33 by the assembler. At this time, the retaining wall 336 is used to retain the assembly position of the plurality of supporting columns 334 so that the assembly heights of the plurality of supporting columns 334 are uniform. On the other hand, the bearing block 332 includes a body 337 and a second mounting hole 338 disposed on the body 337. The body 337 and the retaining wall 336 jointly restrict the plurality of supporting columns 334, and the second mounting hole 338 is located offset from the center of the body 337, the second mounting hole 338 comprises a diameter corresponding to the transmission shaft 32. Therefore, with reference to FIG. 5, the body 337 of the present invention comprises a size smaller than the inner diameter of the outer ring member 331 to be formed with a distance, and the diameter of each of the plurality of supporting columns 334 is set equal to the distance so that the plurality of supporting columns 334 are specifically restricted to the column mounting space 333.

Referring to FIG. 1 and FIG. 4, in one embodiment, the power assembly 30 further includes a stop cap 34 disposed corresponding to the bearing block 332 and penetrated by the transmission shaft 32. Specifically, the stop cap 34 is provided only on one side of the eccentric driving wheel 33, and this side of the eccentric driving wheel 33 is not provided with the retaining wall 336. Thus, the stop cap 34 and the retaining wall 336 retain jointly the plurality of supporting columns 334. Further, the stop cap 34 retains each of the plurality of supporting columns 334, but the state of the stop cap 34 may be appropriately adjusted according to implementation requirements. Therefore, the stop cap 34 does not completely shield the plurality of supporting columns 334 as depicted in the figure of the present invention. That is, some of the plurality of supporting columns 334 will not be completely shielded by the stop cap 34. Further, the stop cap 34 includes a first mounting hole 341 formed in the stop cap 34, and the first mounting hole 341 is disposed corresponding to the second mounting hole 338.

Referring again to FIG. 1, FIG. 2, and FIG. 3, in one embodiment, the movable blade 20 is divided into a blade section 21 and a connecting section 22 integrally extending from the blade section 21. The blade section 21 is assembled correspondingly to the fixed blade 13 and is protruded outside the mounting opening 12 when assembled, and the connecting section 22 is located in the assembly space 11. Furthermore, the connecting section 22 is in interlocking relationship with the eccentric driving wheel 33. In one embodiment, the connecting section 22 of the movable blade 20 is formed by two arms 221, 222 spaced at interval, and the two arms 221, 222 comprise a spacing 60 between the two arms 221, 222 and disposed at two opposite ends of the eccentric driving wheel 33. Therefore, when the eccentric driving wheel 33 is displaced relatively upward, one of the arms 221, 222 (such as arm 221) is forced to push the movable blade 20. In turn, when the eccentric driving wheel 33 is displaced relatively downward, the other arm (such as the arm 222) is pushed by the eccentric driving wheel 33. Thus, the movable blade 20 is allowed to perform the shearing stroke by the eccentric driving wheel 33. On the other hand, the ring wall 335 of the outer ring member 331 may be an arcuate wall surface for the outer ring member 331 specifically pushing the movable blade 20.

In one embodiment, as shown in FIG. 1 and FIG. 2, the tool housing 10 may be a multi-piece assembled housing so that the pneumatic scissor tool 100 is conveniently disassembled and repaired. The tool housing 10 includes a first housing half 14 for in which provides the pneumatic motor 31 to dispose, and a second housing half 15 connected with the first housing half 14 and formed with the mounting opening 12. In other words, the power assembly 30 could be removed from the first housing half 14 after the pneumatic scissor tool 100 is disassembled, and the fixed blade 13 and the movable blade 20 are disposed in the second housing half 15.

What is claimed is:

1. A pneumatic scissor tool comprising:
a tool housing, comprising an assembly space formed in the tool housing, a mounting opening communicated with the assembly space, and at least one fixed blade arranged at the mounting opening;
a movable blade, arranged at the mounting opening corresponding to the fixed blade; and
a power assembly, comprising a pneumatic motor arranged in the assembly space, a transmission shaft connected with the pneumatic motor, an eccentric driving wheel connected with the transmission shaft and driving the movable blade to perform a shearing stroke when rotating, wherein the eccentric driving wheel comprises an outer ring member for pushing the movable blade, a bearing block arranged in the outer ring member and installed with the transmission shaft in an eccentric manner, a column mounting space formed between the outer ring member and the bearing block, and a plurality of supporting columns arranged in the column mounting space and tightly connected with each other.

2. The pneumatic scissor tool of claim 1, wherein the outer ring member comprises a ring wall and a retaining wall extending from one side of the ring wall toward the direction of the column mounting space to retain the plurality of supporting columns.

3. The pneumatic scissor tool of claim 2, wherein the ring wall is an arcuate wall.

4. The pneumatic scissor tool of claim 2, wherein a distance is located between the retaining wall and the bearing block, and a diameter of each of the plurality of supporting columns is equal to the distance.

5. The pneumatic scissor tool of claim 1, wherein the power assembly comprises a stop cap disposed corresponding to the bearing block and penetrated by the transmission shaft, the stop cap disposed in an eccentric manner relative to the bearing block.

6. The pneumatic scissor tool of claim 5, wherein the stop cap includes a first mounting hole formed in the stop cap.

7. The pneumatic scissor tool of claim 1, wherein the bearing block includes a body contacting the plurality of supporting columns and a second mounting hole formed in the body and assembled to the transmission shaft, the second mounting hole is offset from a center of the body.

8. The pneumatic scissor tool of claim 1, wherein the movable blade includes a blade section arranged at the mounting opening corresponding to the fixed blade, and a connecting section extending from the blade section and pushed by the eccentric driving wheel.

9. The pneumatic scissor tool of claim 8, wherein the connecting section of the movable blade is formed by two arms spaced at interval and disposed at two opposite ends of the eccentric driving wheel.

10. The pneumatic scissor tool of claim 1, wherein the tool housing comprises a first housing half in which provides the pneumatic motor to dispose, and a second housing half assembled with the first housing half and formed with the mounting opening.
